(19) United States
(12) Patent Application Publication
(10) Pub. No.: US 2026/0219204 A1
(43) Pub. Date: Jul. 30, 2026

(54) METHOD FOR CONTACTLESS IN-LINE INSPECTION OF CONTAINERS, AND STATION FOR IMPLEMENTING SAME

(71) Applicant: TIAMA, SAINT-GENIS-LAVAL (FR)

(72) Inventors: Laurent COSNEAU, SOUCIEU-EN-JARREST (FR); Etienne LEPRAT, SAINTE FOY LES LYON (FR)

(73) Assignee: TIAMA, SAINT-GENIS-LAVAL (FR)

(21) Appl. No.: 19/143,433

(22) PCT Filed: Dec. 22, 2023
(86) PCT No.: PCT/FR2023/052120

§ 371 Date: Jun. 26, 2025

(30) Foreign Application Priority Data
Dec. 27, 2022 (FR) FR2214525

(51) Int. Cl. G01N 21/90; G01N 21/88

(52) U.S. Cl. CPC G01N 21/9009; G01N 21/8806; G01N 21/9054; G01N 2021/8829; G01N 2021/8841; G01N 2201/102

(57) ABSTRACT

The invention relates to a method for the in-line inspection of containers each having a vertical axis and at least one external profile to be inspected. According to the method, the measuring head is configured to acquire, by optical projection, images of at least one external profile of each container. According to the method, for each movement cycle, the measuring head is positioned such that the axis of rotation of the measuring head is substantially coaxial to the vertical axis of the container as the measuring head rotated of the in a circular movement and the measuring head is moved linearly and parallel to the direction of translation so as to acquire images of the external profile over the entire periphery of the container.

### TECHNICAL FIELD

This invention relates to the technical field of the inspection of transparent or translucent containers, such as for example, bottles, pots, vials, ampoules or syringes made for example of glass or Polyethylene Terephthalate (PET).

The subject of the invention more specifically relates to the field of the inspection of such containers, for the purpose of monitoring or assessing dimensional features exhibited by these containers, such as measurements, and also detecting defects of burr or pit type.

The subject of the invention has particularly advantageous, though non-exclusive, applications in the measuring of container diameters such as the outer diameters of the rings or bodies of containers, or the revealing of the presence of defects on the rings of such containers, particularly at the horizontal mold seam.

### PRIOR ART

In the field of container manufacturing, it is known to inspect the rings of the containers to detect the presence of defects liable to affect their appearance or, more seriously, to be a genuine danger to the user, such as burrs or pits near the neck. It is also known to inspect the neckring of each container to determine whether or not dimensional criteria are complied with, particularly to ensure the correct corking and uncorking of the containers, the sealing of a capsule, of a lid or of a screw cap, particularly by the flatness of the neckring surface, or else the correct affixing of a capsule or of a screw cap according to the geometry of the threads of the neckring of the glass or PET container. The prior art has made provision for various devices for the optical inspection of containers.

For example, patent U.S. Pat. No. 5,753,905 makes provision for an apparatus for inspecting the outer features of containers including a light source illuminating, from one side of the container, the outer profile of the container and recovering, via a camera located on the other side of the container, an image of the profile of the container appearing in the form of a dark image against a pale background. While the container is rotationally driven over one revolution about its vertical axis, images are captured by the camera at each increment of rotation in order to inspect the entire periphery of the container. This inspection apparatus has a rate limited by the handling of the container, which does not make it possible to control the containers with the known manufacturing rates on container manufacturing lines. Specifically, inspection machines that handle rotating containers impose a disruption of the flow of translational transportation along the conveyor belt, then a transportation to rotation and inspection stations, then a return to the line on the conveyor belts. These automated mechanical operations limit the maximum rate on the inspection lines. Moreover, these machines, which handle the rotating containers, must be adapted whenever there is a change in the format of the inspected containers, which requires many manual operations, in particular the replacement of variable equipment for adapting the means of transportation to the shape and dimensions of the series of containers to be produced. Finally, these equipment items are very expensive to buy and in terms of operating and maintenance costs.

In the prior art, from document DE 10 2019 121 835 a method is known for measuring the wall thickness of containers moving in a queue along a manufacturing line. This method is implemented using a measuring head which is continuously displaced, circumventing a first container while this container is linearly displaced. During its movement all around the container, the measuring head projects a light onto the container along a direction or optical axis constantly orthogonal to the surface of the glass container and the light specularly reflected by the glass container is received by the measuring head. The thickness of the wall is measured by means of a contactless optical measuring method which is determined on the basis of the light received by the measuring head. After it has gone all the way around the first container, the displacement of the measuring head is repeated to reiterate the measuring method on a second container following the first container in the queue.

According to the exemplary embodiment described, the measuring head is displaced using a robot with a pivot arm. The solution described by this document has the advantage of being able to inspect the containers without stopping their linear displacement in the queue. However, this document does not allow for the measurement of the diameter of the containers or for revealing the presence of defects on the rings of such containers. Moreover, the kinematics of the measuring head are relatively complex to implement and do not make it possible to keep up with the high travel speeds of the containers which may reach several hundreds of containers per minute. Specifically, such a displacing robot composed of different pivot axes leads to the creation of moment arms of great amplitude and significant inertial forces involved. In the same sense, the mounting of the measuring head on the pivot arm of a robot leads to problems of payload, deformation and wear, making the industrial production of a reliable and economically viable measuring solution difficult. In addition, to keep up the rates needed for the inspection of the containers on the manufacturing lines, the cost of a powerful and fast robot is high.

U.S. Pat. No. 5,296,701 A discloses a method for inspecting containers in which a container is stopped, and a head located above the container then acquires the image of the mouth of said container by pivoting around it. Such a device does not provide satisfaction since it requires the stopping of the travel of the bottle, and does not allow for the production of an outer profile.

EP 3 597 549 A1 which deals with the more remote technical field of the processing of bottles during their filling, describes a system comprising a carousel on which bottles are placed with a given spacing. A plurality of shuttles or movable trolleys bearing a camera able to test the level of filling of the liquid are disposed in a closed circuit and track a bottle over a portion of the carousel. Such a device is not beneficial since it requires perfect synchronization between conveyor belts and bottles. A single slipping of a bottle on a conventional conveyor belt would have the effect of making this system unusable.

Furthermore, such a system requires the use of a plurality of shuttles, and a plurality of sensors or cameras, and is not cost-effective. Finally, such a system prevents the production of an outer profile.

### SUMMARY OF THE INVENTION

This invention has the aim of remedying the drawbacks of the prior art by making provision for a method designed for the in-line inspection of the outer profile of containers over their entire periphery using a safe and economically acceptable technique even though the containers have a high travel rate.

To achieve this aim, the method in accordance with the invention has the aim of inspecting the line of containers each having a vertical axis and at least one outer profile to be inspected; according to this method, the containers are displaced in a conveying plane, in the vertical position in a queue along a direction of translation to successively travel through an inspection station including a contactless measuring head having an axis of rotation about which the measuring head is mounted to rotate, and the measuring head is displaced in successive displacement cycles to successively inspect the containers during their translation past the inspection station, each displacement cycle to inspect a container including an outward journey and a return journey and a rotation to inspect the entire periphery of the container. According to the method:
the measuring head is configured to acquire, by optical projection, images of at least one outer profile of each container,
for each displacement cycle, the measuring head is positioned such that the axis of rotation is substantially coaxial with the vertical axis of the container during the rotation of the measuring head in a circular movement and in linearly displacing the measuring head parallel to the direction of translation in such a way as to acquire images of the outer profile over the entire periphery of the container.

According to an exemplary embodiment, the measuring head is configured to acquire, by optical projection, images of an outer profile of each container and in that for each displacement cycle, the measuring head is rotated over an angular range of at least 360° in such a way as to acquire images of the outer profile over the entire periphery of the container.

According to another exemplary embodiment, the measuring head is configured to acquire, by optical projection, images of two diametrically opposed portions of an outer profile of a container and in that for each displacement cycle, the measuring head is rotated over an angular range of at least 180° in such a way as to acquire images of the outer profile over the entire periphery of the container.

Advantageously, for each displacement cycle, the measuring head is rotated over a range of at least 180° on the outward journey of the measuring head concurrently with the linear displacement of the measuring head, the measuring head being displaced without rotation linearly on the return journey.

Typically, for two successive displacement cycles of the measuring head in relation to two successive containers, the rotation of the measuring head is performed in reverse directions.

According to a feature of the invention, the measuring head is configured to have an engagement volume for a container so that the vertical axis of the container can be substantially coaxial with the axis of rotation of the measuring head and a disengagement volume in order to be able to disengage the measuring head with respect to the container, and the measuring head is displaced to be engaged via its engagement volume, around the container, such that the axis of rotation of the measuring head is substantially coaxial with the vertical axis of the container, and to be disengaged from the container via its disengagement volume.

According to a variant embodiment, the measuring head is configured to include an image-capturing system able to deliver the image of at least a first outer profile of the container in a first field of observation and at least one lighting system illuminating the first field of observation in the background of the first outer profile and in that the image-capturing system is controlled during the rotation of the measuring head to deliver images that contain a projection of the first outer profile of the backlit container.

According to another variant embodiment, the measuring head is configured to include an image-capturing system able to deliver the image of at least a second outer profile of the container, symmetrical to the first outer profile with respect to the vertical axis of the container, in a second field of observation and at least one lighting system illuminating the second field of observation in the background of the second outer profile and the image-capturing system is controlled during the rotation of the measuring head to deliver images that contain a projection of the second outer profile of the backlit container.

Preferably, the method determines the position in the conveying plane of the vertical axis of each container travelling in translation through the inspection station, and the displacement of the measuring head is controlled such that the axis of rotation of the measuring head is substantially coaxial with the vertical axis of the container during the rotation of the measuring head.

Another subject of the invention is to make provision for an in-line inspection station for containers each having a vertical axis and at least one outer profile to be inspected and displaced in the vertical position in a queue by a conveyor belt, along a direction of translation to successively travel through the inspection station, the inspection station including:
a contactless measuring head having an axis of rotation about which the measuring head is mounted to rotate in a circular movement, the measuring head including an image-capturing system able to deliver the image of at least a first outer profile of the container in a first field of observation and at least one lighting system illuminating the first field of observation in the background of the first outer profile,
a structure for displacing the measuring head configured to position the measuring head such that the axis of rotation is substantially coaxial with the vertical axis of the container during the rotation of the measuring head and to linearly displace the measuring head parallel to the direction of translation,
a unit for commanding the measuring head and the displacing structure, receiving the information from a system for determining the position, in the plane of the conveyor belt, of the vertical axis of each container travelling in translation past the inspection station, the command unit being configured to displace the measuring head in successive displacement cycles to successively inspect the containers during their translation through the inspection station, each displacement cycle to inspect a container including an outward journey and a return journey and a rotation to inspect the entire periphery of the container, for each displacement cycle, the displacing structure positions the measuring head such that the axis of rotation is substantially coaxial with the vertical axis of the container during the rotation of the measuring head and linearly displaces the measuring head parallel to the direction of translation, the command unit controlling the image-capturing system in such a way as to acquire images of the outer profile over the entire periphery of the container during the rotation of the measuring head.

According to an exemplary embodiment, the structure for displacing the measuring head includes a motor-driven structure for linearly displacing the measuring head along a direction parallel to the direction of translation, mounted on an assembly movable along a direction perpendicular to the direction of translation, the motor-driven structure being equipped with a frame carrying the measuring head which includes a support rotationally driven about the axis of rotation, by a motor.

Typically, the measuring head is configured to have an engagement volume for a container so that the vertical axis of the container can be substantially coaxial with the axis of rotation of the measuring head and a disengagement volume in order to be able to disengage the measuring head with respect to the container.

For example, the measuring head is configured to have an engagement volume corresponding to the disengagement volume or fashioned to communicate with the disengagement volume to form a volume traversing the support along the direction of translation.

According to a variant embodiment, the image-capturing system is able to deliver the image of at least a second outer profile of the container, symmetrical to the first outer profile with respect to the vertical axis of the container, in a second field of observation and the lighting system illuminates the second field of observation in the background of the second outer profile and the image-capturing system is then controlled during the rotation of the measuring head to deliver images which contain a projection of the profile of the second outer profile of the backlit container.

For example, the image-capturing system includes at least one camera observing the container directly or using at least one fold mirror.

Advantageously, the camera is mounted on the frame while being centered on the axis of rotation, while observing the container using at least one fold mirror mounted on the support rotationally driven about the axis of rotation.

According to another exemplary embodiment, the image-capturing system includes at least one camera mounted on the support rotationally driven about the axis of rotation.

For example, the lighting system includes at least one light source illuminating the container directly or using at least one fold mirror.

According to another example, the lighting system includes at least one light source mounted on the support rotationally driven about the axis of rotation.

### BRIEF DESCRIPTION OF THE DRAWINGS

FIG. 1 is a perspective view of a first exemplary embodiment of an inspection station in accordance with the invention.

FIG. 2 is an elevation view showing the inspection station of FIG. 1 in a first characteristic step.

FIG. 2A is a top view taken substantially along the lines IIA of FIG. 2.

FIG. 2B is a lateral view taken substantially along the lines IIB of FIG. 2.

FIG. 2C is an example of a captured image of a profile of a container, obtained with an inspection station in accordance with FIG. 1.

FIG. 3 is an elevation view showing the inspection station of FIG. 1 in a second characteristic step of inspecting a container.

FIG. 4 is an elevation view showing the inspection station of FIG. 1 in a third characteristic step of inspecting the container that follows the previously-inspected container in the queue.

FIG. 5 is a perspective view of a second exemplary embodiment of an inspection station in accordance with the invention.

FIG. 6 is an elevation view showing the inspection station of FIG. 5 in a first characteristic step of inspecting a container.

FIG. 6A is a top view taken substantially along the lines VIA of FIG. 6.

FIG. 6B is a lateral view taken substantially along the lines VIB of FIG. 6.

FIG. 6C is an example of a captured image of a profile of a container, obtained with an inspection station in accordance with FIG. 5.

FIG. 7 is a top view showing the inspection station of FIG. 5 in a second characteristic step of inspecting a container.

FIG. 8 is a top view showing the inspection station of FIG. 5 in a third characteristic step of inspecting the container that follows the previously-inspected container in the queue.

FIG. 9 is a top view showing the inspection station of FIG. 5 in a fourth characteristic step of inspecting.

FIG. 10 is a top view showing the inspection station of FIG. 5 in a fifth characteristic step of inspecting a container that follows the previously-inspected container in the queue.

FIG. 11 is a top schematic view showing an exemplary embodiment of a system for capturing images of two opposing profiles of a container using a camera and fold mirrors.

FIG. 12 is a top schematic view showing an exemplary embodiment of a system for capturing images of two opposing profiles of a container using a camera without any fold mirror.

FIG. 13 is a top schematic view showing an exemplary embodiment of a system for capturing images of two opposing profiles of a container using two cameras without any fold mirror.

FIG. 14A is a top schematic view showing an exemplary embodiment of a measuring head in a position awaiting engagement for a container.

FIG. 14B is a top schematic view showing an exemplary embodiment of a measuring head in a position in which a container is engaged in the measuring head.

FIG. 14C is a top schematic view showing an exemplary embodiment of a measuring head in an intermediate position of rotation about the container for capturing images.

FIG. 14D is a top schematic view showing an exemplary embodiment of a measuring head in a position for which the container is disengaging from the measuring head.

FIG. 14E is a top schematic view showing an exemplary embodiment of a measuring head in a position for which the measuring head is returned to its position awaiting engagement for a new container.

FIG. 15 is an elevation section view of a variant embodiment of the measuring head for which the camera and the light source are mounted on the fixed part of the measuring head.

FIG. 15A is a section view taken substantially along the lines XVA of FIG. 15.

FIG. 15B is a section view taken substantially along the lines XVB of FIG. 15.

### DESCRIPTION OF THE EMBODIMENTS

As can be seen from the drawings, the subject of the invention relates to a method and an inspection station 1 making it possible to automatically acquire images of the outer profile of containers 2 being displaced to travel at high speed. The invention relates to the so-called “in-line” control of containers, after a step of transformation or manufacturing, in order to control the quality of the containers or of the transformation or manufacturing method.

The method works for a rate of travel of a flow of containers 2. Ideally, the inspection station 1 is capable of handling production at the production rate, for example of 100 to 1000 containers per minute and typically around 500 containers per minute.

The invention provides a considerable improvement owing to the inspection of containers as they travel, by avoiding the rotating of containers which is not suitable for production rates, since this arrangement, which involves a relative rotation of the containers with respect to the light sources and/or the sensors, creates a “break in travel” or a very slow displacement of the containers.

In a known manner, the containers 2 that have just been formed by an installation of any type known per se, are managed by a conveyor belt 3 to form a queue of containers by being, in the illustrated example, placed successively in the vertical position on the conveyor belt. The containers 2 are transported in a queue by the conveyor belt 3 having a horizontal conveying plane defined by a longitudinal axis X parallel to the direction of translation and by a transverse axis Y perpendicular to the direction of translation. As can be seen on the drawings, the containers 2 are displaced in a queue in a conveying plane X, Y, along a direction of translation F parallel to the longitudinal axis X, and in a vertical position taken with respect to a vertical axis Z perpendicular to the conveying plane X, Y.

Advantageously, the containers 2 are containers made of transparent or translucent material such as for example bottles, pots, vials, ampoules or syringes made of glass or PET. In the examples illustrated by the drawings, each container 2 has a bottom 2f resting on the conveyor belt 3 and from which a vertical wall 2v ending in a so-called neckring part 2b rises up along a vertical axis 2z. The neckring 2b has a neckring surface 2s, corresponding to the flat surface for the sealing of the container and a lateral wall 2l, having for example reliefs suitable for gripping in the case of syringes or for attaching any system for closing the containers, such as for example the crimping of a capsule, the screwing of a screw cover, the retainment of a press-fitted collar or wire cage, the different closing systems not being shown here but widely known. In the case of a container 2 of bottle type, the vertical wall 2v has from the bottom 2f, a part forming the body of the bottle which connects to a neck 2c by way of a shoulder 2e. The vertical wall 2v is cylindrical, conical or of any section such as square, rectangular or kidney-shaped such as for vials. One advantage of the neckring inspection solution is that the method and inspection station 1 in accordance with the invention are suitable for any shape of container body.

The containers 2 are transported by the conveyor belt 3 in order to convey them successively to different handling and inspection stations. As can be seen on the drawings, the containers 2 are displaced in the vertical position in the queue along the direction of translation F to travel successively through the inspection station 1 in accordance with the invention. The inspection station 1 is installed in proximity to the conveyor belt 3 to be able to inspect each container 2. The inspection station 1 is embodied in a fixed area limited in length with respect to the length of the conveyor belt and at any appropriate place according to the nature of the inspection to be perform.

The inspection station 1 includes a measuring head 4 configured to acquire, by optical projection and without contact, images of the outer profile of the container over the entire periphery of each container 2 travelling through the inspection station. The measuring head 4 has an axis of rotation a about which the measuring head 4 is mounted to rotate in a circular movement either in a clockwise direction schematically represented by the arrow h or in an anticlockwise direction schematically represented by the arrow ah. This measuring head 4 includes an image-capturing system 5 able to deliver the image of at least a first outer profile Pe of the container 2 in a first field of observation C and at least one lighting system 6 illuminating the first field of observation C in the background of the first outer profile.

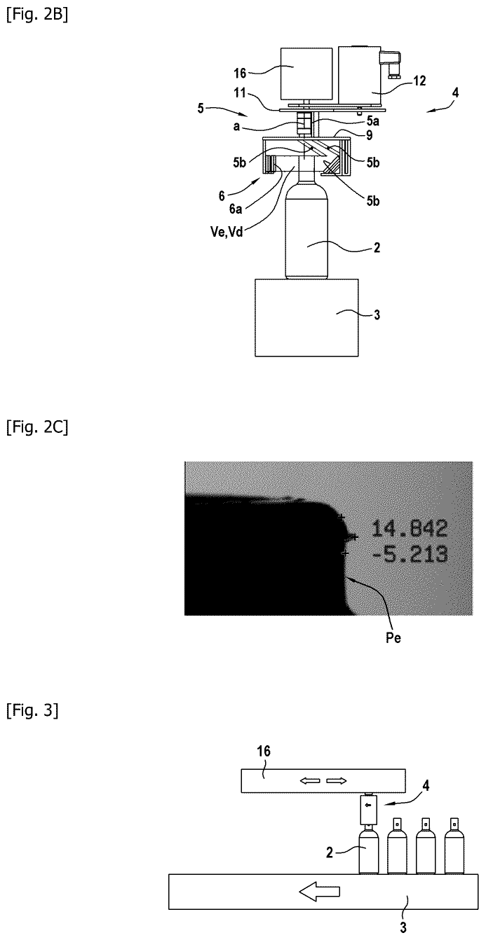

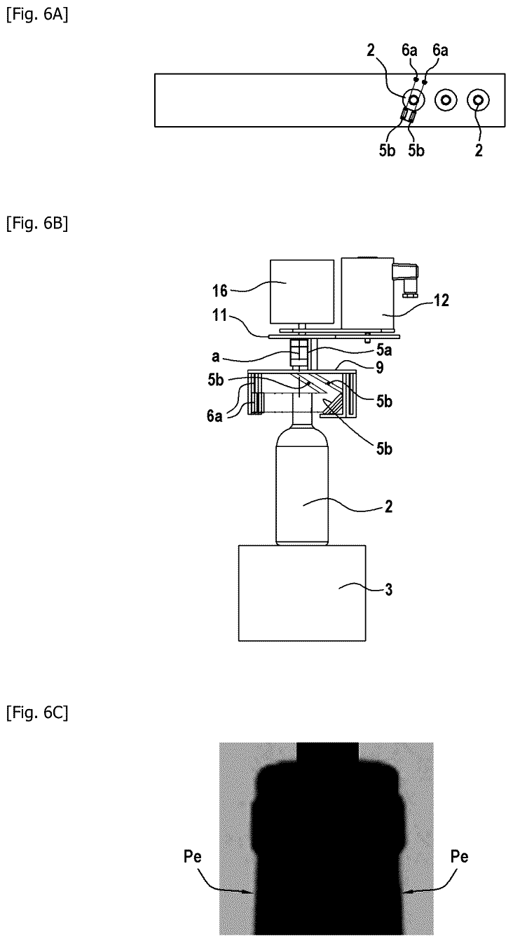

The outer profile Pe of the container 2 corresponds to the outline of at least a part of the container, taken in a plane passing through the vertical axis Z and perpendicular to the conveying plane X-Y. According to the example illustrated in FIG. 2C, the image-capturing system 5 acquires an outer profile Pe of the container 2 corresponding to one side of the neckring 2b and a part of the neckring surface 2s of the container. According to the example illustrated in FIG. 6C, the image-capturing system 5 acquires a first outer profile Pe of the container 2 corresponding to one side of the neckring 2b and to a part of the neckring surface 2s of the container and a second outer profile Pe of the container 2 corresponding to the symmetrical side of the neckring 2b and to a part of the neckring surface 2s of the container. Of course, the outer profile Pe of the container 2 may correspond to other parts of the container such as the body of the container for example.

As will be described in detail in the remainder of the description, this measuring head 4 is mounted to rotate for the purpose of inspecting the entire periphery of the container 2. Images of the outer profile Pe of the container are thus acquired during the rotation at each increment. The acquisition of images of the outer profile Pe of the container 2 around its entire circumference by the measuring head 4 makes it possible to assess dimensional features exhibited by these containers such as diameters of the rings or diameters of the bodies of these containers. It is also possible to reveal defects such as defects on the rings of such containers, as for the horizontal mold seam for example.

The image-capturing system 5 and the lighting system 6 are mounted in any appropriate manner on the measuring head 4 to ensure, by optical projection, the acquisition of at least a number of outer profiles of the containers. According to an exemplary embodiment illustrated on FIGS. 2B and 6B, the measuring head 4 includes a support 9 supported by a frame 11. The support 9 is rotationally driven with respect to the frame 11, about the axis of rotation a, in both directions of rotation by a motor 12 of any known type, such as an electric motor. The motor 12, which is mounted on the frame 11, rotationally drives the support 9, directly or by way of a mechanical transmission. The support 9 is rotationally guided in any appropriate manner with respect to the frame 11. In other words, the support 9 forms the rotationally movable part of the measuring head 4 with respect to the frame 11 which forms the fixed part of the measuring head.

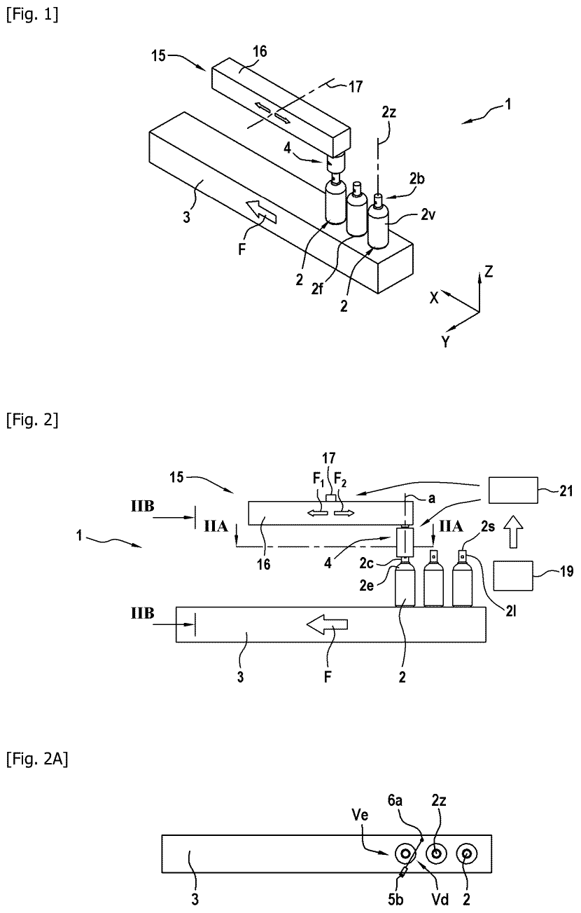

According to the exemplary embodiment illustrated in FIGS. 1, 2, 2A, 2B and 2C, the image-capturing system 5 is configured to deliver the image of a single and first outer profile of the container in a first and single field of observation and a lighting system 6 illuminates the first field of observation C in the background of the first outer profile. According to the exemplary embodiment illustrated in FIGS. 5, 6, 6A, 6B, 6C, and 7 to 13, the image-capturing system 5 is configured to deliver the image of a first outer profile in a first field of observation C and of a second outer profile of the container, symmetrical to the first outer profile with respect to the vertical axis a of the container, in a second field of observation C. The lighting system 6 illuminates the first field of observation in the background of the first outer profile and illuminates the second field of observation in the background of the second outer profile.

The image-capturing system 5 includes at least one camera 5a with its lens, observing the container 2 directly or using at least one fold mirror 5b. The lighting system 6 includes at least one light source 6a illuminating the container 2 directly or using the at least one fold mirror 6b.

As illustrated in FIGS. 2A and 2B, the image-capturing system 5 includes a camera 5a observing the container 2 using three fold mirrors 5b disposed between the camera 5a and the container. According to this example, these fold mirrors 5 b each have an angle of deflection of 45° with respect to the axis of rotation a. In this example, the camera 5a is mounted on the frame 11 while being centered on the axis of rotation a, and observing the container 2 using the fold mirrors 5b mounted on the support 9. Of course, each fold mirror 5b extends along the vertical axis Z at a height adapted to the height of the part of the container to be observed. For example, the support 9 takes the form of a disc extending from its lower face, by a structure extending along the vertical axis Z to allow the attachment of the fold mirrors 5b to direct the light to the camera.

According to this example, the lighting system 6 includes a light source 6a mounted on the support 9 to illuminate the field of observation of the camera 5a. The light source 6a is attached on the lower face of the support 9 in such a way that the light source 6a and a fold mirror 5a are located on either side of the container while tangentially illuminating an edge of the container 2 in order to be able to image the outer profile of the container. Thus, the container 2 is positioned in the field of the camera 5a which can be direct or folded by fold mirrors 5b. The container 2 is then positioned on the path of the light between a light source 6a and an image-capturing camera 5a, of which the optical axis of observation, direct or folded by fold mirrors 5b, is positioned in such a way that the profile of the container is optically projected in an image with the source in the background. More precisely, the arrangement makes it possible to visualize the profile projected in the image by light rays tangent to the edge of the container.

According to the exemplary embodiment illustrated in FIGS. 6A and 6B, the image-capturing system 5 includes a camera 5a configured to observe the container 2 in two fields of observation using fold mirrors 5b. According to this example, the camera 5a is mounted on the frame 11 while being centered on the axis of rotation a, and observing the container 2 using the fold mirrors 5b mounted on the support 9 to observe the first outer profile and the second outer profile of the container, symmetrical with respect to the vertical axis a. The lighting system 6 includes two light sources 6a mounted on the support 9 to illuminate the two fields of observation of the camera 5a. The light sources 6a are attached to the lower face of the support 9 in such a way that for each light source 6a and fold mirror 5b pair, the light sources 6a and the fold mirrors 5b are located on either side of the container, tangentially illuminating the two edges of the container 2 in order to be able to image two symmetrical or diametrically opposed outer profiles of the container.

In the examples described above, the camera 5a is mounted on the frame 11 such that the camera is fixed with respect to the rotationally driven support 9.

According to another non-illustrated exemplary embodiment, it should be noted that the camera 5a can be mounted on the support 9 rotationally driven about the axis of rotation. In this solution, the camera 5a is mounted directly on the support 9 in place of the fold mirror 5b or on the support 9 combined with a fold mirror 5b.

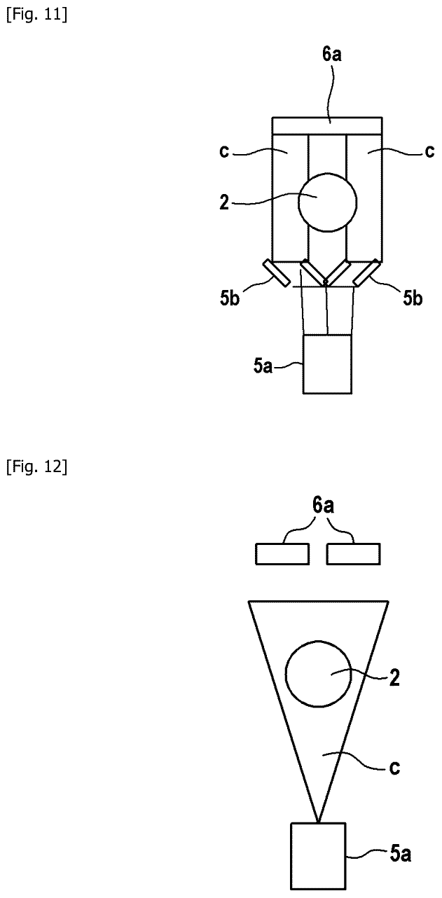

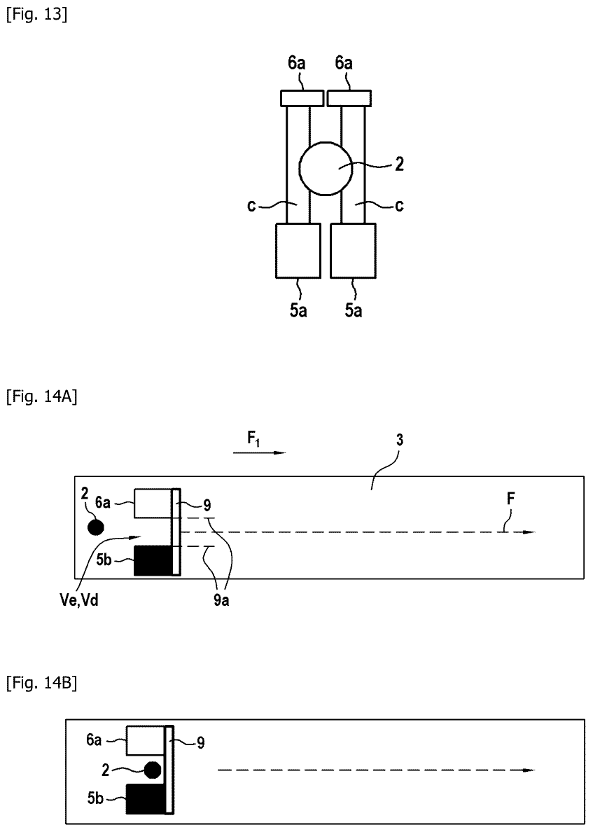

In the same direction, it should be noted that in the exemplary embodiment illustrated in FIGS. 6A and 6B, a single camera 5a observes the container 2 in two different fields of observation C using two sets of fold mirrors 5b. The optical diagram of this set-up is illustrated in FIG. 11. Of course, as illustrated in FIG. 12, the image-capturing system 5 may include a camera 5a directly observing the container 2 in a field of observation C covering the two opposite sides of the container to image the two diametrically opposed outer profiles of the container. Similarly, as illustrated in FIG. 13, the image-capturing system 5 can include two cameras 5a each directly observing the container 2 in two different fields of observation C.

In the exemplary embodiments described in FIGS. 2A, 2B and 6A, 6B, the lighting system 6 respectively includes one light source or two light sources 6a mounted on the support 9 rotationally driven about the axis of rotation. It should be noted, as illustrated on FIG. 11, that the two fields of observation C can be illuminated by a single light source or, as illustrated in FIG. 12, by two light sources. Similarly, in the examples illustrated above, the container 2 is illuminated directly by the light source or sources 6a mounted on the support 9. Of course, the light source or sources can illuminate the container 2 using at least one reflector or fold mirror 6b attached to the support 9.

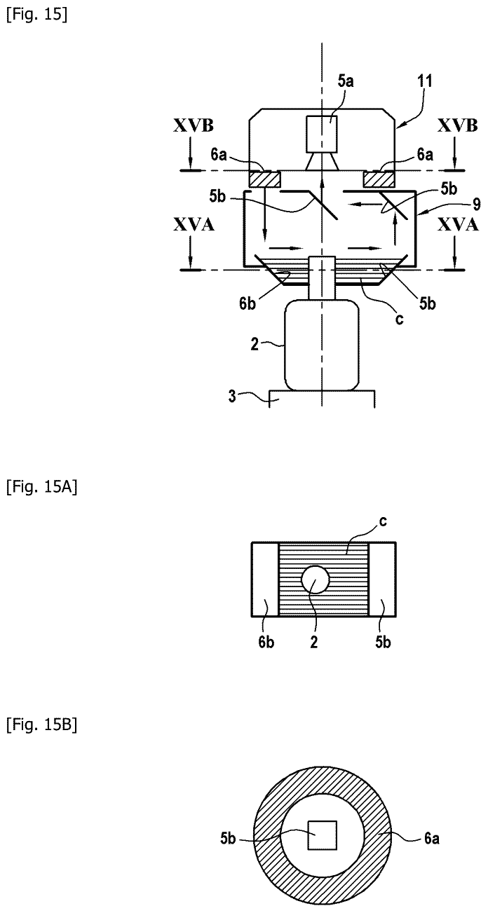

FIGS. 15, 15A and 15B illustrate such a variant embodiment for which the light source 6a is an annular light source attached to the frame 11 and illuminating a fold mirror 6b attached to the support 9 rotationally driven about the axis of rotation a. This lighting fold mirror 6b is positioned in such a way as to reflect the light coming from a portion or from an angular section of the light source 6a located above it, this portion of the annular light source varying during the rotation of the support 9. According to this exemplary embodiment, it is possible to make provision for the light source 6a to be controlled in independent sections for the purpose of lighting the only sector located in vertical coincidence with the lighting fold mirror 6b. On FIG. 15, the arrows indicate the direction of travel of the light. This fold mirror 6b of the light is positioned to extend on one side of the container while a fold mirror 5b of the image-capturing system 5 is attached to the support 9 to extend on the other side of the container 2 (FIGS. 15 and 15A).

The image-capturing system 5 includes two other fold mirrors 5b disposed between this first fold mirror 5b and the lens of the camera 5a attached to the frame 11, with its optical axis coaxial with the axis of rotation a. These three fold mirrors 5b have for example an angle of 45° with the horizontal to bring the image of the profile of the container into the optical axis of the camera. It should be noted that the folding of the field of observation C toward the camera 5a can be done with, in all, not three but two fold mirrors 5b having different angles with respect to the horizontal. Of course, the fold mirror or mirrors 5b of the image-capturing system can be replaced by prisms, as can the lighting fold mirrors 6b. It should be noted that according to this variant embodiment, the light source 6a and the camera 5a are mounted on the frame 11 i.e. on the fixed part of the measuring head 4. This solution avoids either the use of power or signal transmission cables between the fixed part (frame 11) and the movable part (support 9) of the measuring head or the use of cable-free signal and power transmission means, of rotary contact, optical and/or magnetic coupling type between the fixed part (frame 11) and the movable part (support 9) of the measuring head.

According to another feature, the inspection station 1 includes a structure 15 for displacing the measuring head 4, configured to position the measuring head 4 such that the axis of rotation a is substantially coaxial with the vertical axis 2z of the container 2 during the rotation of the measuring head and to linearly displace the measuring head 4 parallel to the direction of translation F. The frame 11 of the measuring head 4 is therefore displaced by the displacing structure 15 to position the axis of rotation a of the support 9 in a manner substantially coaxial with the vertical axis 2z of the container 2. According to an exemplary embodiment, the displacing structure 15 for the measuring head 4 includes a motor-driven structure 16 for the linear displacement of the measuring head along a direction parallel to the direction of translation F of the conveyor belt.

This motor-driven structure 16 is equipped with the frame 11 carrying the measuring head 4 in such a way that the measuring head 4 can be linearly displaced back and forth along the direction of translation F. For example, this motor-driven structure 16 is composed of a linear guiding system which supports the measuring head 4. The linear guiding is of any type, for example one or two rails along which the movable frame 11, mounted for example on bearings, slides. The measuring head 4 or the movable frame 11 is drawn by a linear motor or by a toothed conveyor belt driven by a pinion driven by a rotary motor.

It should be noted that the motor-driven structure 16 and the containers 2 may require a relative alignment in the transverse direction Y, in order to keep the axis of rotation a of the measuring head substantially coaxial with the vertical axis 2z of the containers 2. The relative alignment can be done as a function of the position along the determined transverse direction Y of each container in order to compensate for their variation in position along the transverse direction Y, or else as a function of the position along the determined transverse direction Y of the part of each examined container (the neckring for example) in order to compensate not only for their variation in position along this direction but also for the variations in verticality of each container. To do this, a first solution consists in displacing the motor-driven structure 16 along the transverse direction Y as a function of the determined position of each container or part of container examined. This motor-driven structure 16 is for example mounted on an assembly 17 movable along the transverse direction Y perpendicular to the direction of translation F. The combination of the motion of the assembly 17 and of the motor-driven structure 16 makes it possible to position the measuring head 4 in any position in the conveying plane X, Y. An alternative to dispense with the displacement of the measuring head 4 along the transverse direction Y is to displace the containers along the transverse direction Y before they enter the inspection station 1 or as they are transported through the station, by means of a motor-driven transverse centering system. However, it is also possible to dispense with the displacement of the measuring head 4 along the transverse direction Y if the field of observation of the image-capturing system 5 is wide and if the measuring head 4 has a large transverse capacity for housing the containers.

According to an advantageous feature of embodiment, the displacing structure 15 is configured to also be able to adjust the position of the measuring head 4 along the vertical axis Z. This adjustment possibility makes it possible to adapt the position of the measuring head 4 with respect to the height of the containers 2 and to the area of the containers to be inspected. This height adjustment is advantageously done before the inspection operation, in the strict sense, of a series of containers to be inspected, generally of substantially identical heights.

The result of the preceding description is that the displacing structure 15 of the measuring head 4 is configured to be mounted overhanging the containers 2 i.e. the conveyor belt 3. The measuring head 4 is positioned above the containers such that the axis of rotation a can extend substantially coaxially with the vertical axis 2z of the container. However, in order to be able to image the outer profile of the container, the image-capturing system 5 and the lighting system 6 must be positioned on the sides of the container. Thus, the support 9 is positioned above the containers 2 extending in the direction of the conveyor belt 3 in such a way that the image-capturing system 5 and the lighting system 6 can extend on either side of the sides of the container 2. It should be noted that the positioning along the vertical axis Z, of the image-capturing system 5 and the lighting system 6, depends on the area of the profile of the container to be imaged. If the outer profile of the container to be imaged concerns the neckring, the image-capturing system 5 and the lighting system 6 are positioned level with the neckring of the container. If the outer profile of the container to be imaged concerns the body of the container, the image-capturing system 5 and the lighting system 6 are positioned on either side of the body of the container 2. In this case, the support 9 extends along the vertical axis Z, over a greater height than in the case in which the outer profile of the neckring is imaged in order to correctly position the image-capturing system 5 and the lighting system 6 with respect to the body of the container.

According to an advantageous feature, the measuring head 4 is kept at the same altitude along the vertical axis Z during its displacement for the inspection of the different containers 2. In other words, the measuring head 4 is positioned to be traversed by the containers 2 with the image-capturing system 5 and the lighting system 6 which extend on the sides of the container. It must be understood that the measuring head 4 is positioned on the path of travel of the containers, without modifying their straight path. Each container 2 is therefore laterally engaged in the measuring head 4 which is displaced through the inspection station 1 to follow the movement of travel of the container.

The measuring head 4 and more precisely the support 9 is configured to have an engagement volume Ve for a container 2 so that the vertical axis 2z of the container can be substantially coaxial with the axis of rotation a of the measuring head 4 and a disengagement volume Vd to be able to disengage the measuring head 4 with respect to the container. This engagement volume and this disengagement volume, which correspond to free volumes, are defined between the image-capturing system 5 and the lighting system 6 to make it possible to position the container in such a way that the axis of rotation a of the measuring head 4 is coaxial with the vertical axis of the container 2.

In the examples illustrated in FIGS. 2B and 6B, the support 9 is configured to have an engagement volume Ve fashioned to communicate with the disengagement volume Vd to form a volume traversing the support 9 along the direction of translation. Thus, the measuring head 4 can be engaged via its traversing volume around a container 2. During the rotation of the measuring head 4 and its linear displacement, the container remains engaged in this volume. For the disengagement of the container, the support 9 is positioned so that the disengagement volume is oriented along the direction of translation.

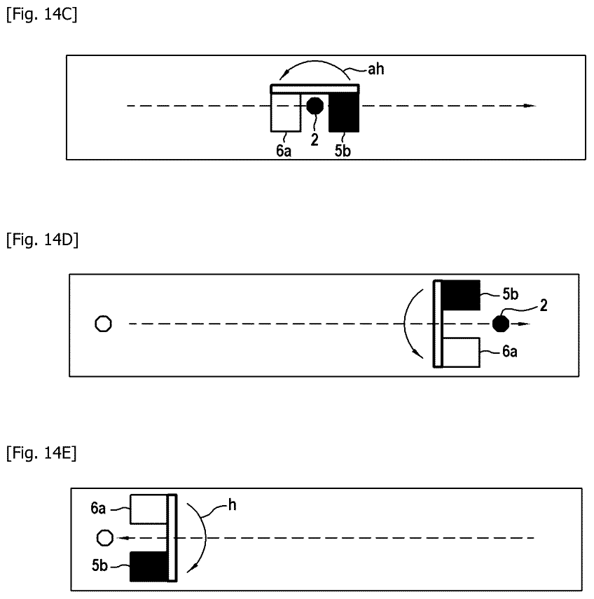

FIGS. 14A to 14E illustrate another variant embodiment for which the support 9 is configured to have an engagement volume Ve equivalent to the disengagement volume Vd. It should be noted that the engagement volume and the disengagement volume can be made of traversing type by eliminating the part of the support 9 located between the lines 9a (FIG. 14A).

According to another feature of the invention, the inspection station 1 includes a system 19 for determining the position along at least the direction of translation X of the vertical axis 2z of each container travelling in translation through the inspection station 1. In practice, according to an exemplary embodiment, this determining system 19 is configured to determine the position of the vertical axis 2z of each container along the direction of translation X, before the containers 2 enter the inspection station, and considers that the translation speed of the containers is constant between the occurrence of a detection and the passage through the inspection station. It should be noted that this determining system 19 can take into account the position along the longitudinal axis X of each container during all or part of its journey through the inspection station.

This determining system 19 is of necessity configured to know the position of the containers 2 along the direction of translation X but it can be configured to also determine the position in the transverse direction Y. The determining system 19 can determine at least the position along the direction of translation X, or even the position in the conveying plane X and Y of each container (or of their neckring), several times or continuously during their journey through the inspection station 1. The position along the direction of translation X or in the conveying plane X, Y can also be obtained directly by the measuring head 4 and the analysis of the captured images of the container. Specifically, on the one hand the position of the measuring head 4 in rotation about the axis of rotation a and in translation along the direction of translation X is known and on the other hand, the position of each container (or of its neckring) in the field of observation is also known, based on a profile taking into account the nominal diameter of the container at this height, or still more accurately when the measuring head observes two opposite profiles at the same time, the axis of the container being able to be located in the images as the middle of the two profiles. It is possible to combine several location systems, such as a light curtain system to control the placement, at the entrance of the inspection station, of the container in the field of observation, then the keeping of the axis of rotation a coaxial with the axis of the container during the journey through the inspection station.

This determining system 19 can be embodied in any appropriate way, using for example a system taking into account the speed of the conveyor belt 3 and one or two cells (optical barriers) or at least one camera for capturing images of the containers before they enter the inspection station 1. This determining system 19 thus makes it possible to know the position in the conveying plane of the vertical axis 2z of each container during its displacement through the inspection station 1.

According to another feature of the invention, the inspection station 1 includes a command unit 21 for the measuring head 4 and for the displacing structure 15, receiving the information from the determining system 19 of the position of the vertical axis 2z of each container 2. This command unit 21 is configured to displace the measuring head 4 in successive displacement cycles to inspect without contact, in succession, the containers during their translational passage through the inspection station 1. Each displacement cycle for inspecting a container 2 includes an outward journey with a rotation to inspect the entire periphery of the container and a return journey. For each displacement cycle, the command unit 21 controls the displacing structure 15 to position the measuring head 4 such that the axis of rotation a is substantially coaxial with the vertical axis 2z of the container during the rotation of the measuring head 4. The command unit 21 controls the operation of the motor 12 to perform the rotation of the measuring head 4 and of the displacing structure 15 to concurrently displace the measuring head parallel to the direction of translation F while keeping the axis of rotation substantially coaxial with the vertical axis 2z of the container. The command unit 21 controls the image-capturing system 5 in such a way as to acquire images of the outer profile over the entire periphery of the container during the rotation of the measuring head 4.

This command unit 21 is embodied in any appropriate way to displace the measuring head 4 and acquire images over the entire periphery of each container 2. The command unit 21 includes units of axis control board or power variators in order to control the rotary and/or linear motors. This command unit 21 is also an electronic data processing unit implementing a computer system of any type including computers, external peripherals (display units, storage unit, keyboards, connection to different factory networks etc.), programs, databases, etc. The images captured by the cameras are analyzed for the purpose of ensuring quality control, in particular to monitor or assess dimensional features of the containers and/or to observe or analyze defects of the containers.

The inspection station 1 as described above makes it possible to implement an in-line method for inspecting containers which directly results from the preceding description.

According to such a method, the containers 2 are displaced in the vertical position in a queue along the direction of translation F to successively travel through the inspection station 1 in accordance with the invention including the measuring head 4. The method according to the invention aims to displace the measuring head 4 in successive displacement cycles to successively inspect, without contact, the containers 2 during their translation through the inspection station. It must be understood that the inspection of the containers 2 is performed without modifying the translation travel of the containers imposed by the conveyor belt 3.

By definition, each displacement cycle of the measuring head 4 has the aim of inspecting, without contact, a container 2 translationally driven by the conveyor belt 3. Each displacement cycle for inspecting a container 2 includes an outward journey with a rotation of the measuring head to inspect the entire periphery of the container and a return journey. To position the measuring head 4 with respect to each container 2 travelling through the inspection station 1, the method according to the invention determines the position along the direction of translation F of the vertical axis 2z of each container 2 translationally travelling through the inspection station. For this purpose, the command unit 21 receives the information from the system 19 which determines at least the position, along the direction of translation F, of the vertical axis 2z of each container 2. The command unit 21 controls the displacement of the measuring head 4 such that the axis of rotation a of the measuring head 4 is substantially coaxial with the vertical axis 2z of the container when the measuring head is rotating. Moreover, it should be noted that the command unit 21 controls the displacement of the measuring head 4 and in particular the motor 12 such that the engagement volume Ve of the measuring head is then positioned to allow the engagement of the measuring head around the container 2 so that the vertical axis 2z of the container can be substantially coaxial with the axis of rotation a of the measuring head.

During the outward journey, the measuring head 4 is displaced to follow the translational movement of the container 2. The measuring head 4 is displaced parallel to the direction of translation F. The command unit 21 controls the displacing structure 15 and more precisely the motor-driven linear displacing structure 16 in the direction F1, in the same direction as the direction of displacement of the container. During the outward journey, the measuring head is positioned such that the axis of rotation a of the measuring head 4 is substantially coaxial with the vertical axis 2z of the container when the measuring head is rotated. “Substantially coaxial” means that, as a minimum, the command unit 21 controls the displacing structure 15 according to the position of the container in such a way that the analyzed profiles remain in the field of observation of the measuring head 4. When the determining system 19 determines at least the position along the direction of translation (longitudinal axis X) of each container or of their neckring, several times or continuously during their journey through the inspection station, then the command unit 21 controls the displacing structure 15 and more precisely the motor-driven linear displacing structure 16 to keep, by servo control, the axis of rotation a of the measuring head 4 substantially coaxial with the vertical axis 2z of the container during their journey through the inspection station 1.

Provision can be made for the command unit 21 to control the displacing structure 15 and in particular the movable assembly 17 according to the position of the container along the transverse axis Y. The combination of the displacements of the measuring head 4 along the axes X, Y allows the measuring head to have its axis of rotation a coaxial with the vertical axis 2z of the container. Provision can also be made for the same command unit 21 to also control a motor-driven member for transverse centering of the containers as explained previously, before they enter the inspection station 1 or as they are transported through the inspection station 1.

During the outward journey, the measuring head 4 is rotationally controlled to inspect the entire periphery of the container 2 while the axis of rotation a of the measuring head remains substantially coaxial with the vertical axis 2z of the container. It is recalled that the measuring head 4 is translationally displaced so that the axis of rotation a of the measuring head remains substantially coaxial with the vertical axis 2z of the container. The command unit 21 controls the motor 12 to rotate the measuring head 4 while the measuring head is translationally displaced. Simultaneously, the command unit 21 controls the camera or cameras 5a and optionally the light source or sources 6a if these latters are commanded to light up in a flash or pulse mode only during the image acquisition phase.

In accordance with the invention, the measuring head 4 is configured to acquire, by optical projection, images of at least one outer profile of each container 2. Also, for the acquisition of profile images, the command unit 21 controls the camera or cameras 5a in such a way that at each increment of rotation of the container, an image is captured such that the number of images per revolution is greater, for example, than 36. In other words, the method has the aim of acquiring at least one image every 10° of rotation of the container 2. For example, the number of images of a container 2 over 360° is between 36 and 96 or 360. The increment of rotation of the container between each captured image represents an angular sector crossed by the container ranging for example from 10° to less than 3.75° or 1°. The limitations on the number of images are related to the optoelectronics (maximum video frequency of the camera, sensitiveness of the sensor), the maximum brightness of the light source, generally an LED source, and the volume of data it is possible to transfer, store and analyze (memory capacity, transmission speed and computing power of the processors).

The outward journey of an inspection cycle of a container 2 is followed by a return journey for which the measuring head 4 is brought back to a suitable position for inspecting the following container in the queue.

At the end of the outward journey, it should be noted that the command unit 21 controls the displacement of the measuring head 4 and in particular the motor 12 such that the disengagement volume Vd of the measuring head is then positioned to allow the disengagement of the measuring head with respect to the container 2 so that the container can continue its displacement. For the return journey, the command unit 21 controls the displacing structure 15 and more precisely the motor-driven linear displacing structure 16 in the direction F2, in the opposite direction to the direction of displacement of the containers. It should be noted that during most of the return journey, no container is present in the inspection station 1.

The command unit 21 optionally controls the movable assembly 17 in such a way as to anticipate the position of the measuring head 4 with respect to the next container to be inspected. At the end of the return journey, the measuring head 4 is for example brought substantially back to its initial position, which it had at the start of the displacement cycle. The command unit 21 controls the displacement of the measuring head 4 to perform a new inspection cycle for the following container in the queue.

FIGS. 1, 2, 2A, 2B and 2C illustrate a first exemplary embodiment of the inspection method in accordance with the invention for which the image-capturing system 5 is configured to deliver the image of a single outer profile of the container in a field of observation illuminated in the background of the outer profile by the lighting system 6. According to this exemplary embodiment, for each displacement cycle, the measuring head 4 is rotated over an angular range of at least 360° in such a way as to acquire images of the outer profile over the entire periphery of the container 2.

For a displacement cycle for the purpose of inspecting a container 2, the command unit 21 that receives the information from the system 19, controls the displacement of the measuring head 4 and in particular the motor 12 such that the engagement volume Ve of the measuring head is then positioned to allow the engagement of the measuring head around the container 2 (FIGS. 2, 2A). After the positioning of the measuring head such that the axis of rotation a of the measuring head 4 is substantially coaxial with the vertical axis 2z of the container, the command unit 21 controls the motor-driven linear displacing structure 16 in the direction F1, and also controls the motor 12 to rotate the measuring head 4 over at least 360° and 380° for example. Simultaneously, the command unit 21 controls the camera 5a as well as the light source to acquire profile images over the entire periphery of the container (FIG. 3).

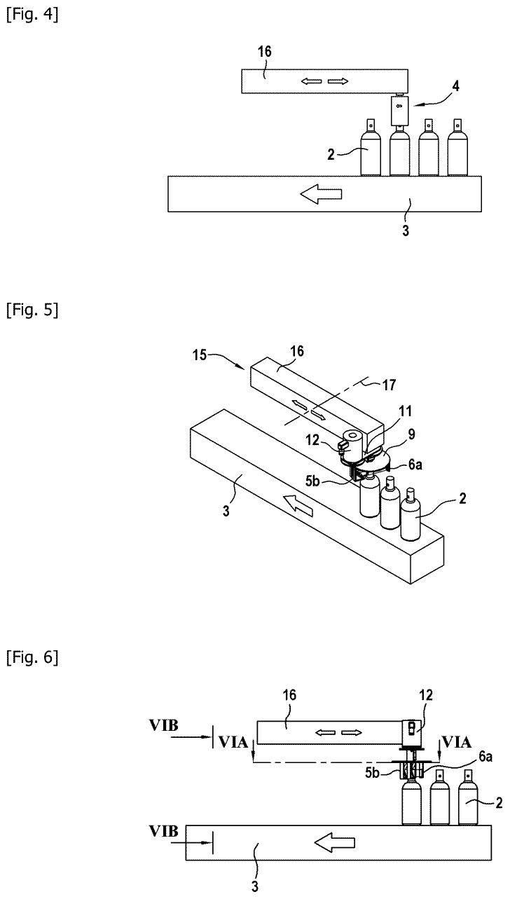

At the end of the outward journey, the command unit 21 controls the displacement of the measuring head 4 and in particular the motor 12 such that the disengagement volume Vd of the measuring head is then positioned to allow the disengagement of the measuring head with respect to the container 2. The command unit 21 controls the displacing structure 15 for the return journey of the measuring head 4 for the purpose of bringing it back into a position allowing it to perform a new inspection cycle for the following container in the queue (FIG. 4).

FIGS. 5, 6, 6A, 6B, 6C, and 7 to 10, illustrate a second exemplary embodiment of the inspection method in accordance with the invention for which the image-capturing system 5 is configured to deliver the image of a first outer profile in a first field of observation and a second outer profile of the container, symmetrical to the first outer profile with respect to the vertical axis 2z of the container, in a second field of observation. As can be seen from FIG. 6C, this example makes it possible to acquire the two symmetrical outer profiles of a neckring for example. It should be noted that this example makes it possible to also acquire the inner profile of the neckring allowing measurements of dimensions over the inner diameter of the mouth of the container.

According to this preferred embodiment, the measuring head 4 is rotated over an angular range of at least 180° in such a way as to acquire images of the outer profile over the entire periphery of the container. Advantageously, the command unit 21 controls the motor 12 to rotate the measuring head 4 over an angular range between 180° and 220°. By comparison with a method in which the rotation of the measuring head 4 is of 380°, this method allows for a faster inspection, since for identical transportation and rotation speeds, the length of the inspection station 1 is divided by two, and/or a more stable inspection with an identical speed and distance of translation but a rotation speed divided by two, and/or an inspection with better resolution since with an identical speed and distance of translation, and a rotation speed divided by two, it is possible to capture images spaced apart by an increment of rotation divided by two.

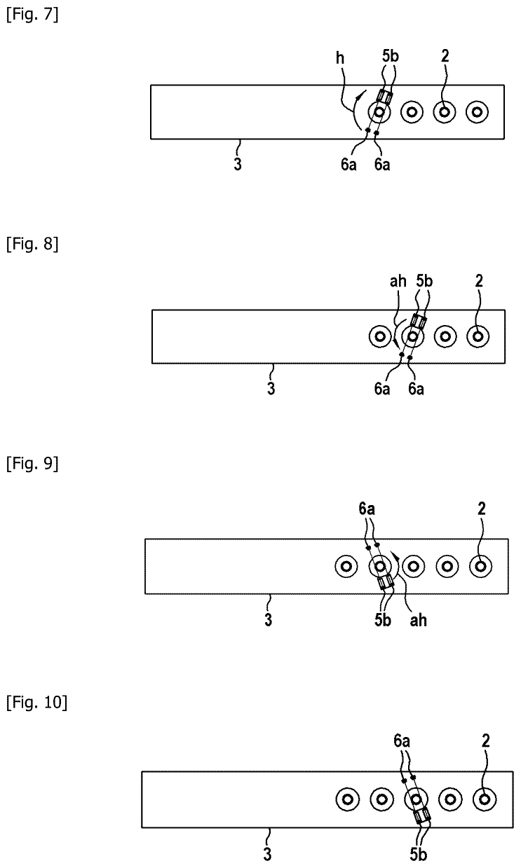

For a displacement cycle for the purpose of inspecting a container 2, the command unit 21 that has received the information from the system 19 controls the displacement of the measuring head 4 and in particular the motor 12 such that the engagement volume Ve of the measuring head is then positioned to allow the engagement of the measuring head around the container 2 (FIG. 6A). After the positioning of the measuring head such that the axis of rotation a of the measuring head 4 is substantially coaxial with the vertical axis 2z of the container, the command unit 21 controls the motor-driven linear displacing structure 16 in the direction F1, and also controls the motor 12 to rotate the measuring head 4 over 220° for example, in the clockwise direction h. Simultaneously, the command unit 21 controls the camera 5a as well as the light sources 6a to acquire profile images over the entire periphery of the container (FIG. 7).

At the end of the outward journey, the command unit 21 controls the displacement of the measuring head 4 and in particular the motor 12 such that the disengagement volume Vd of the measuring head is then positioned to allow the disengagement of the measuring head with respect to the container 2. The command unit 21 controls the displacing structure 15 for the return journey of the measuring head 4 for the purpose of positioning the measuring head ready to perform a new inspection cycle for the following container in the queue (FIG. 8). It should be noted that in the scenario where the measuring head 4 has a traversing engagement and disengagement volume, the measuring head 4 is oriented, upon the exit of a container, in a correct position to receive a new container. In other words, the measuring head 4 keeps its orientation between the position in which a container leaves the measuring head and the position in which a new container is engaged in the measuring head (FIGS. 7 and 8). Thus, during the return journey, the measuring head 4 is simply in translation, without rotation, whatever the amplitude of rotation on the outward journey. It should be noted that a measuring head 4 with a traversing engagement and disengagement volume offers another advantage when it malfunctions or stops, since the measuring head does not block the translational travel of the containers. A measuring head 4 having a traversing volume for the engagement volume and the disengagement volume and a rotation limited to 180° constitutes a preferred variant embodiment.

The measuring head 4 is then able to inspect the following container in the queue. For this new displacement cycle for the purpose of inspecting this container 2, the command unit 21 that has received the information from the system 19 controls the measuring head such that the axis of rotation a of the measuring head 4 is substantially coaxial with the vertical axis 2z of the container. The command unit 21 controls the displacing structure 15 in particular the motor-driven linear displacement structure 16 in the direction F1, and also controls the motor 12 to rotate the measuring head 4 over 220° for example, in the anticlockwise direction ah. Simultaneously, the command unit 21 controls the camera 5a as well as the light sources 6a to acquire profile images over the entire periphery of the container (FIG. 9).

At the end of the outward journey, the command unit 21 controls the displacing structure 15 for the return journey of the measuring head 4 for the purpose of positioning the measuring head ready to perform a new inspection cycle for the following container in the queue (FIG. 10).

From this exemplary implementation for each displacement cycle, it can be seen that the measuring head 4 is rotated over a range of at least 180° on the outward journey of the measuring head 4 concurrently with the linear displacement of the measuring head while the measuring head 4 is displaced without rotation linearly on the return journey. Thus, for two successive displacement cycles of the measuring head 4 in relation to two successive containers on the queue, the rotation of the measuring head 4 is done in reverse directions. The rotation in alternating directions of the measuring head 4 offers the advantage of being able to control the winding of the power cables of the measuring head 4 when the light source and/or camera is/are rotationally secured to the support 9. Of course, the problem of winding and unwinding of cables does not exist if the light source and the camera are fixed with respect to the frame 11 (FIG. 15) or if cable-free signal and power transmission means are used, of rotary contact, optical and/or magnetic coupling type between the light sources or camera on board the rotating support 9 and the frame 11. An example of a rotary contact cable is a connector for a coaxial cable used to power and control a camera as per the communication standard known as CoaxPress®.

FIGS. 14A to 14E illustrate a third exemplary implementation of the inspection method in accordance with the invention for which the measuring head 4 is configured to have an engagement volume Ve equivalent to the disengagement volume Vd. FIG. 14A illustrates the positioning of the engagement volume over the path of the container 2 to be inspected. In this position, the container 2 can enter the measuring head 4 such that the light source 6a and the fold mirror 5b are located on either side of the container (FIG. 14B).

For a displacement cycle for the purpose of inspecting this container 2, the command unit 21 that has received the information from the system 19 controls the displacing structure 15 such that the axis of rotation a of the measuring head 4 is substantially coaxial with the vertical axis 2z of the container. The command unit 21 controls the motor-driven linear displacement structure 16 in the direction F1, and simultaneously also controls the motor 12 to rotate the measuring head 4 over 180° to acquire two symmetrical outer profiles or 380° for example in the anticlockwise direction ah (FIGS. 14C and 14D). Simultaneously, the command unit 21 controls the camera 5a as well as the light source to acquire profile images over the entire periphery of the container during the rotation of the measuring head.

At the end of the outward journey, the disengagement volume Vd of the measuring head is then positioned to allow the disengagement of the measuring head with respect to the container 2. The command unit 21 controls the motor-driven linear displacement structure 16 in the direction F2 for the purpose of bringing the measuring head into a position allowing it to perform a new inspection cycle for the following container in the queue. Moreover, the command unit 21 controls the motor 12 in the clockwise direction h such that the engagement volume Vd of the measuring head is then positioned to allow the engagement of the measuring head with respect to a new container 2 (FIG. 14E).

From this variant embodiment for which the engagement volume Ve is equivalent to the disengagement volume Vd it can be seen that it is advisable to rotate the measuring head during the return journey in order to put the engagement volume Ve back on the side on which the following container arrives. Moreover, if there are any cables between the frame 11 and the support 9 because of the mounting of the light sources and cameras, the rotation of the support 9 during the return journey is in the reverse direction to the rotation of the support 9 during the outward journey. It should be noted that the rotation during the return journey can be of any amount if the cameras and light sources are fixed to the frame 11 using deflection mirrors or if the power and signal transmissions are made by means of rotary contacts (mainly power), optical couplings (signals only) or magnetic couplings.

The preferred variant aims not to rotate the measuring head during the return journey. This preferred variant without rotation on the return journey is much faster, since during the return journey there is no need to control the rotation, and there is no Coriolis effect. For example, the return journey is made at a translation speed 30% greater than that of the outward journey. This return journey in translation only is possible in the following scenarios:
the rotation on the outward journey is of approximately 360°, whether the engagement Ve or disengagement Vd volumes are traversing or non-traversing,
the engagement Ve and disengagement Vd volumes constitute a traversing volume, whether the rotation is of 180° or 360°.

In other words, the return journey with a rotation is only necessary if the measuring head does not have any traversing engagement and disengagement volumes and if the rotation is limited to 180° (FIGS. 14A to 14E).

It should also be noted that the control laws for the translational motion during the outward journey, and in particular the accelerations, are such that at the start of the outward journey, in a phase of calibration or entry into the station, the axis of rotation a is quickly but gradually brought into coincidence with the vertical axis 2z of the containers, the axis a being, during the calibration phase, either ahead of or lagging behind the vertical axis 2z. The same reasoning is applicable in a phase of exiting the inspection station, therefore at the end of the outward journey and at the start of the return journey.

1. A method for the in-line inspection of containers each having a vertical axis and at least one outer profile to be inspected; according to the method, the containers are displaced in a conveying plane in the vertical position in a queue along a direction of translation to successively travel through an inspection station including a contactless measuring head having an axis of rotation (a) about which the measuring head is mounted to rotate, and the measuring head is displaced in successive displacement cycles to successively inspect the containers during their translation past the inspection station, each displacement cycle to inspect a container including an outward journey and a return journey and a rotation to inspect the entire periphery of the container,
the method comprising:
configuring the measuring head to acquire, by optical projection, images of at least one outer profile of each container,
for each displacement cycle, positioning the measuring head such that the axis of rotation is substantially coaxial with the vertical axis of the container during the rotation of the measuring head in a circular movement and in linearly displacing the measuring head parallel to the direction of translation in such a way as to acquire images of the outer profile over the entire periphery of the container.

2. The method as claimed in claim 1, wherein the measuring head is configured to acquire, by optical projection, images of an outer profile of each container and wherein for each displacement cycle, the measuring head is rotated over an angular range of at least 360° in such a way as to acquire images of the outer profile over the entire periphery of the container.

3. The method as claimed in claim 1, wherein the measuring head is configured to acquire, by optical projection, images of two diametrically opposed portions of an outer profile of a container and wherein for each displacement cycle, the measuring head is rotated over an angular range of at least 180° in such a way as to acquire images of the outer profile over the entire periphery of the container.

4. The method as claimed in claim 3, wherein for each displacement cycle, the measuring head is rotated over a range of at least 180° on the outward journey of the measuring head concurrently with the linear displacement of the measuring head, the measuring head being displaced without rotation linearly on the return journey.

5. The method as claimed in one claim 1, wherein for two successive displacement cycles of the measuring head in relation to two successive containers, the rotation of the measuring head is performed in reverse directions.

6. The method as claimed in claim 1, wherein the measuring head is configured to have an engagement volume for a container so that the vertical axis of the container can be substantially coaxial with the axis of rotation of the measuring head and a disengagement volume in order to be able to disengage the measuring head with respect to the container, and wherein the measuring head is displaced to be engaged via its engagement volume, around the container, such that the axis of rotation of the measuring head is substantially coaxial with the vertical axis of the container, and to be disengaged from the container via its disengagement volume.

7. The method as claimed in claim 1, wherein the measuring head is configured to include an image-capturing system able to deliver the image of at least a first outer profile of the container in a first field of observation and at least one lighting system illuminating the first field of observation in the background of the first outer profile and wherein the image-capturing system is controlled during the rotation of the measuring head to deliver images that contain a projection of the first outer profile of the backlit container.

8. The method as claimed in claim 7, wherein the measuring head is configured to include an image-capturing system able to deliver the image of at least a second outer profile of the container, symmetrical to the first outer profile with respect to the vertical axis of the container, in a second field of observation and at least one lighting system illuminating the second field of observation in the background of the second outer profile and wherein the image-capturing system is controlled during the rotation of the measuring head to deliver images that contain a projection of the second outer profile of the backlit container.

9. The method as claimed in one claim 1, wherein is determined the position in the conveying plane of the vertical axis of each container travelling in translation through the inspection station, and wherein the displacement of the measuring head is controlled such that the axis of rotation of the measuring head is substantially coaxial with the vertical axis of the container during the rotation of the measuring head.

10. An in-line inspection station for containers each having a vertical axis and at least one outer profile to be inspected and displaced in the vertical position in a queue by a conveyor belt along a direction of translation to successively travel through the inspection station, the inspection station including:
a contactless measuring head having an axis of rotation about which the measuring head is mounted to rotate in a circular movement, the measuring head including an image-capturing system able to deliver the image of at least a first outer profile of the container in a first field of observation and at least one lighting system illuminating the first field of observation in the background of the first outer profile,
a structure for displacing the measuring head configured to position the measuring head such that the axis of rotation is substantially coaxial with the vertical axis of the container during the rotation of the measuring head and to linearly displace the measuring head parallel to the direction of translation,
a unit for commanding the measuring head and the displacing structure receiving the information from a system for determining the position, in the plane of the conveyor belt, of the vertical axis of each container travelling in translation past the inspection station, the command unit being configured to displace the measuring head in successive displacement cycles to successively inspect the containers during their translation through the inspection station, each displacement cycle to inspect a container including an outward journey and a return journey and a rotation to inspect the entire periphery of the container, for each displacement cycle, the displacing structure positions the measuring head such that the axis of rotation is substantially coaxial with the vertical axis of the container during the rotation of the measuring head and linearly displaces the measuring head parallel to the direction of translation, the command unit controlling the image-capturing system in such a way as to acquire images of the outer profile over the entire periphery of the container during the rotation of the measuring head.

11. The inspection station as claimed in claim 10, wherein the structure for displacing the measuring head includes a motor-driven structure for linearly displacing the measuring head along a direction parallel to the direction of translation, mounted on an assembly movable along a direction perpendicular to the direction of translation, the motor-driven structure being equipped with a frame carrying the measuring head which includes a support rotationally driven about the axis of rotation, by a motor.

12. The inspection station as claimed in claim 11, wherein the measuring head is configured to have an engagement volume for a container so that the vertical axis of the container can be substantially coaxial with the axis of rotation of the measuring head and a disengagement volume in order to be able to disengage the measuring head with respect to the container.

13. The inspection station as claimed in claim 12, wherein the measuring head is configured to have an engagement volume corresponding to the disengagement volume or fashioned to communicate with the disengagement volume to form a volume traversing the support along the direction of translation.

14. The inspection station as claimed in on claim 10, wherein the image-capturing system is able to deliver the image of at least a second outer profile of the container, symmetrical to the first outer profile with respect to the vertical axis of the container, in a second field of observation and the lighting system illuminates the second field of observation in the background of the second outer profile and wherein the image-capturing system is then controlled during the rotation of the measuring head to deliver images which contain a projection of the profile of the second outer profile of the backlit container.

15. The inspection station as claimed in one of claims 10, wherein the image-capturing system includes at least one camera observing the container directly or using at least one fold mirror.

16. The inspection station as claimed in claim 15, wherein the camera is mounted on the frame while being centered on the axis of rotation, while observing the container using at least one fold mirror mounted on the support rotationally driven about the axis of rotation.

17. The inspection station as claimed in claim 15, wherein the image-capturing system includes at least one camera mounted on the support rotationally driven about the axis of rotation.

18. The inspection station as claimed in claim 10, wherein the lighting system includes at least one light source illuminating the container directly or using at least one fold mirror.

19. The inspection station as claimed in claim 18, wherein the lighting system includes at least one light source mounted on the support rotationally driven about the axis of rotation.
